(19) United States
(12) Patent Application Publication
(10) Pub. No.: US 2011/0055386 A1
(43) Pub. Date: Mar. 3, 2011

(54) NETWORK ANALYTICS MANAGEMENT

(75) Inventors: Ted Middleton, Moorpark, CA (US); Christopher Newton, Westlake Village, CA (US)

(73) Assignee: Level 3 Communications, LLC

(21) Appl. No.: 12/836,438

(22) Filed: Jul. 14, 2010

Related U.S. Application Data
(60) Provisional application No. 61/238,682, filed on Aug. 31, 2009.

(51) Int. Cl. G06F 15/16

(52) U.S. Cl. 709/224

(57) ABSTRACT

Embodiments generally disclosed herein include a methods and systems configured for providing network analytics for a content delivery network. The methods and systems include providing a content delivery network comprising at least one content server. The methods and systems further include detecting a request for network analytics from the content delivery network and extracting network analytics at the at least one content server. The methods and systems may further include disseminating the network analytics from the content delivery network.

### CROSS-REFERENCE TO RELATED APPLICATIONS

This application claims the benefit of priority to U.S. Provisional Patent Application 61/238,682, filed Aug. 31, 2009, titled “Network Analytics Management”, which is incorporated herein by reference for all purposes.

### TECHNICAL FIELD

Embodiments presently disclosed relate to network analytics management. More specifically, embodiments presently disclosed relate to network analytics management in a content delivery network.

### BACKGROUND

Internet use has grown tremendously in recent years. The types and sources of content on the Internet have also grown. For example, computer users often access the Internet to download video, audio, multimedia, or other types of content for business, entertainment, education, or other purposes. Today, users can view live presentations of events, such as sporting events, as well as stored content, such as videos and pictures. The providers of such content typically want to have some level of control over the manner in which the content is viewed and by whom. For example, the provider of videos may want certain videos (e.g., selected videos, or type or class of videos) to be encrypted upon distribution. Users typically want content “on-demand”, and would prefer not to wait a long time for download before viewing the content. Certain types of content tend to take longer than others to download. For example, download of a movie can take many minutes or hours, depending on the type of download technology used and the size of the movie file.

Typically providers of Internet content are separate entities from the network providers that provide the infrastructure to distribute the content. To reach a very large audience, content providers typically purchase the services of a content delivery network provider, which generally has a large network infrastructure for distributing the content. However, because content providers typically do not have control over distribution, the providers typically have limited control over how, or to whom, the content is distributed. In addition, content providers do not have access to internal network analytics of the content delivery network providers.

Network analytics data, however, are typically collected by vendors running Javascripts running on end user devices. These Javascript-enabled analytics include user-specific interactions with downloaded or streaming content received from a content delivery network. The interactions captured by the Javascript are tagged and sent back to a managed service and include information about a web page viewed, client demographic information, browser information (e.g., cookies). Web page owners can purchase this information from the managed service to optimize their web pages.

### SUMMARY

Web analytics data can be collected by a content delivery network and distributed to analytics engine vendors and services to supplement traditional analytics data captured on an end user device or instead of such analytics data.

A content delivery network receives a request for network analytics; extracts the network analytics from the content delivery network; and disseminates the network analytics from the content delivery network. In an embodiment, the content delivery network packages the network analytics for delivery to a third party, such as an analytics engine or a content publisher.

In one implementation, for example, a content server of a content delivery network is used to collect data such as downloading statistics that can be used as an analytical tool.

Other implementations are also described and recited herein.

### BRIEF DESCRIPTIONS OF THE DRAWINGS

FIG. 1 illustrates an example network environment suitable for distributing content and monitoring analytics according to various embodiments.

FIG. 2 illustrates a system in terms of functional modules for distributing content and monitoring analytics according to various embodiments.

FIG. 3 is a functional module diagram illustrating one possible implementation of a streaming cache module according to various embodiments.

FIG. 4 is a state diagram illustrating one possible set of states that a streaming cache module can enter according to various embodiments.

FIGS. 5-7 are flowcharts illustrating example processes for streaming content.

FIG. 8 illustrates another example network environment suitable for distributing content and monitoring analytics according to various embodiments.

FIG. 8 illustrates yet another example network environment suitable for distributing content and monitoring analytics according to various embodiments.

FIG. 9 illustrates an example network analytics management system.

FIG. 10 illustrates another example network analytics management system.

FIG. 11 illustrates a block diagram of an example process for monitoring and reporting network analytics data.

FIG. 12 is an example block diagram of a computer system configured with a content streaming application and process according to embodiments herein.

### DETAILED DESCRIPTION

Embodiments presently disclosed relate to network analytics management. More specifically, embodiments presently disclosed relate to network analytics management in a content delivery network.

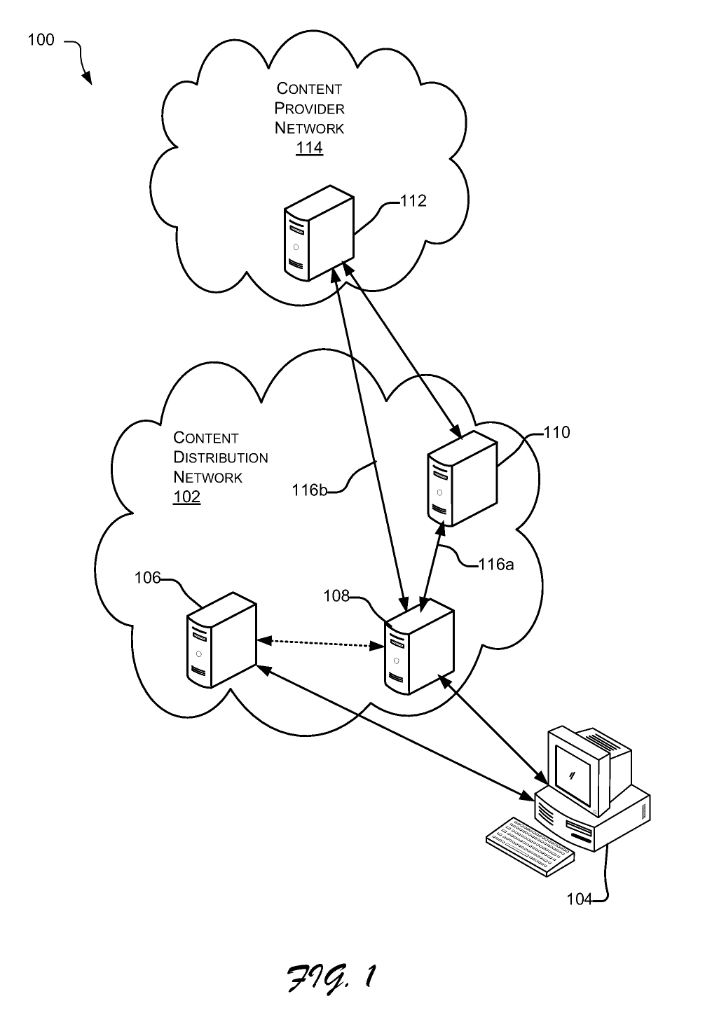

FIG. 1 illustrates an example network environment 100 suitable for distributing content and monitoring and/or analyzing network analytics according to various embodiments. A computer user may access a content distribution network (CDN) 102 using a computing device, such as a desktop computer 104. The CDN 102 is illustrated as a single network for ease of illustration, but in actual operation as described in more detail below, CDN 102 may typically include one or more networks.

For example, network 102 may represent one or more of a service provider network, a wholesale provider network and an intermediate network. The user computer 102 is illustrated as a desktop computer, but the user may use any of numerous different types of computing devices to access the network 102, including, but not limited to, a laptop computer, a handheld computer, a personal digital assistant (PDA), or a cell phone.

The network 102 may be capable of providing content to the computer 104 and monitoring and/or analyzing network analytics for the network environment 100. Content may be any of numerous types of content, including video, audio, images, text, multimedia, or any other type of media. The computer 104 includes an application to receive, process and present content that is downloaded to the computer 104. For example, the computer 104 may include an Internet browser application, such as Internet Explorer™ or Firefox™, and a streaming media player, such as Flash Media Player™ or Quicktime™. When the user of computer 104 selects a link (e.g., a hyperlink) to a particular content item, the user's web browser application causes a request to be sent to a directory server 106, requesting that the directory server provide a network address (e.g., and Internet protocol (IP) address) where the content associated with the link can be obtained.

In some embodiments, directory server 106 is a domain name system (DNS), which resolves an alphanumeric domain name to an IP address. Directory server 106 resolves the link name (e.g., a universal resource locator (URL)) to an associated network address and then notifies the computer 104 of the network address from which the computer 104 can retrieve the selected content item. When the computer 104 receives the network address, the computer 104 then sends a request for the selected content item to a computer, such as streaming server computer 108, associated with the network address supplied by the directory server 106.

In the particular embodiment illustrated, streaming server computer 108 is an edge server of the CDN 102. Edge server computer 108 may be more or less strategically placed within the network 102 to achieve one or more performance objectives such as reducing load on interconnecting networks, freeing up capacity, scalability and lowering delivery costs. The edge server 108, for example, may cache content that originates from another server, so that the cached content is available in a more geographically or logically proximate location to the end user. Such strategic placement of the edge server 108 could reduce content download time to the user computer 104.

Edge server computer 108 is configured to provide requested content to a requester. As used herein, the term “requester” can include any type of entity that could potentially request content, whether the requester is the end user computer or some intermediate device. As such, a requester could be the user computer 104, but could also be another computer, or a router, gateway or switch (not shown) requesting the content from the edge server computer 108. As will be understood, requests generated by the computer 104 are typically routed over numerous “hops” between routers or other devices to the edge server computer 108. Accordingly, a requester of content could be any of numerous devices communicably coupled to the edge server computer 108.

As part of the function of providing requested content, the edge server computer 108 is configured to determine whether the requested content is available locally from the edge server computer 108 to be provided to the requester. In one embodiment, the requested content is available if the content is stored locally in cache and is not stale. In one particular implementation, stale is a condition in which the content is older than a prescribed amount of time, typically designated by a “time-to-live” value, although other measures may also be used. The edge computer server 108 is configured with media streaming server software, such as Flash Media Server™ (FMS) or Windows Media Server™ (WMS). As such, if the requested content is found to be locally stored on the edge computer server 108 and the cached content is not stale, the media streaming software can stream the requested content to the requester, in this case, the computer 104.

If the edge server computer 108 determines that requested content is not available (e.g., is either not locally stored or is stale), the edge server computer 108 takes a remedial action to accommodate the request. If the content is locally stored but is stale, the remedial action involves attempting to revalidate the content. If the content is not locally stored or revalidation fails (in the case of stale content), the edge server computer 108 attempts to retrieve the requested content from another source, such as a media access server. A media access server (MAS) is a server computer that may be able to provide the requested content.

In the illustrated embodiment, two possible media access servers are shown: a content distribution server computer 110 and a content origin server 112. Content origin server 112 is a server computer of a content provider. The content provider may be a customer of a content distribution service provider that operates the network 102. The origin server 112 may reside in a content provider network 114.

In some embodiments, the content origin server 112 is an HTTP server that supports virtual hosting. In this manner, the content server can be configured to host multiple domains for various media and content resources. During an example operation, an HTTP HOST header can be sent to the origin server 112 as part of an HTTP GET request. The HOST header can specify a particular domain hosted by the origin server 112, wherein the particular domain corresponds with a host of the requested content.

The content distribution server 110 is typically a server computer within the content distribution network 102. The content distribution server 110 may reside logically in between the content origin server 112, in the sense that content may be delivered to the content distribution server 110 and then to the edge server computer 108. The content distribution server 110 may also employ content caching.

In some embodiments, the edge server computer 108 locates the media access server by requesting a network address from the directory server 106, or another device operable to determine a network address of a media access server that is capable of providing the content. The edge server computer 108 then sends a request for content to the located media access server. Regardless of which media access server is contacted, the media access server can respond to a request for specified content in several possible ways. The manner of response can depend on the type of request as well as the content associated with the request.

For example, the media access server could provide information to the edge computer server 108 that indicates that the locally cached version of the content on the edge computer server 108 is not stale. Alternatively, the media access server could send the specified content to the edge computer server 108, if the media access server has a non-stale copy of the specified content. In one embodiment, the media access server includes data transport server software, such as a Hypertext Transport Protocol (HTTP) server, or web server. In this case, the edge server computer 108 interacts with the media access server using the data transport protocol employed by the media access server.

With further regard to the communications between the edge server computer 108 and the media access server computer (e.g., either the content origin server 112 or the content distribution server 110), the two servers may communicate over a channel. These channels are illustrated as channel 116a between the edge server computer 108 and the content distribution server 110 and channel 116b between the edge server computer 108 and the content origin server 112. According to various embodiments described herein, channels 116 are data transport, meaning the channels 116 carry data using a data transport protocol, such as HTTP.

The edge server 108 is configured to retrieve content using a data transport protocol while simultaneously streaming content to the content requester. For example, the edge server computer 108 is operable to simultaneously stream requested content to the requester (e.g., the computer 104) while receiving the content from the origin server computer 112 over the data transport protocol channel 116b. Operations carried out by the edge server computer 108 and modules employed by the edge server computer 108 can perform simultaneous streaming and content retrieval.

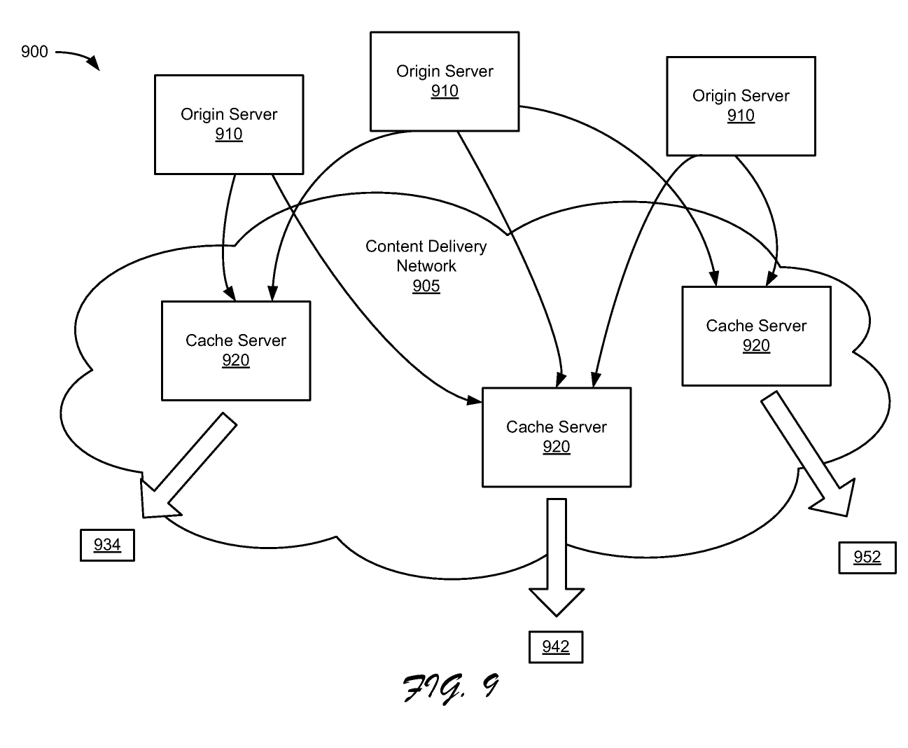

Network analytics are monitored and analyzed within the network environment 100, such as within the content distribution network 102, such as described in more detail below with respect to FIGS. 8-12.

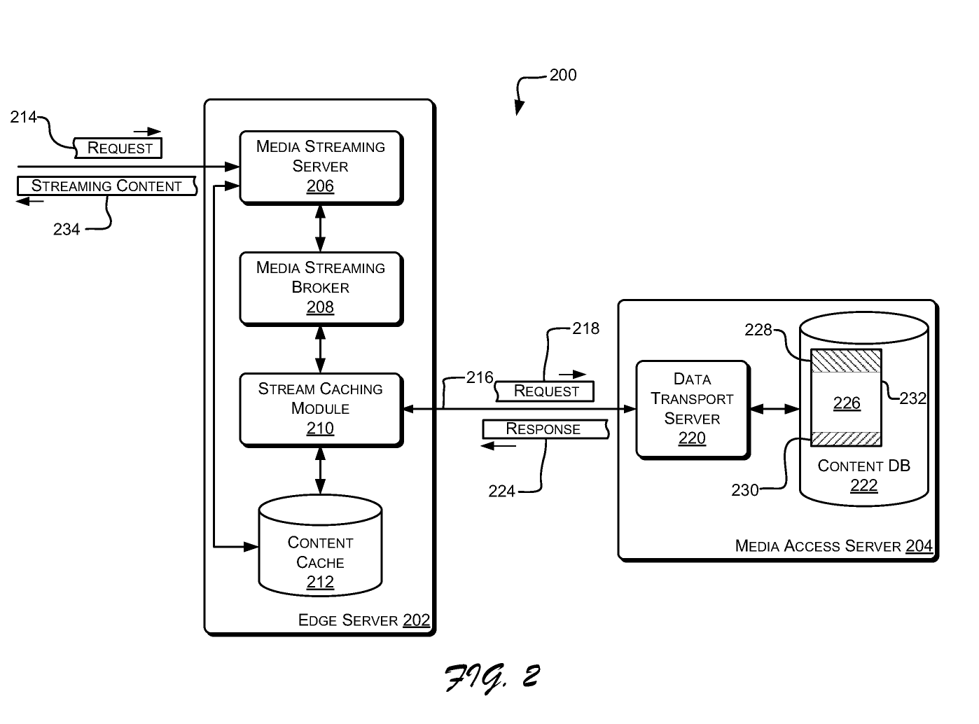

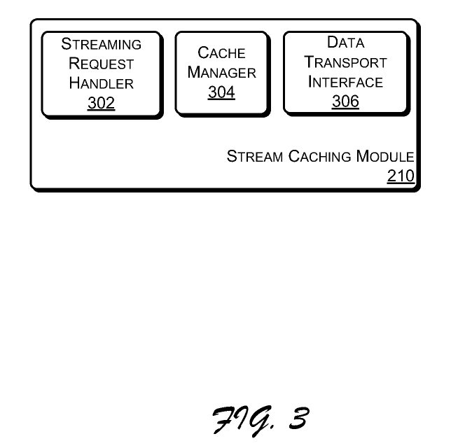

FIG. 2 illustrates a streaming content delivery framework 200 adapted to monitor and/or analyze network analytics including an edge server computer 202 and a media access server computer 204. Edge server computer 202 is configured with modules operable to retrieve content from the MAS 204, if necessary, while streaming the content to an entity that has requested the content. In some embodiments, retrieval of requested content from the MAS 204 is simultaneous with streaming of the content to the requester.

In the embodiment illustrated in FIG. 2, the edge server computer 202 includes a media streaming server 206, a media streaming broker 208, a stream caching module 210 and a content cache 212. In an illustrative scenario, a content request 214 is received from a requester. The content request has various information, including, but not limited to, an identifier of the content being requested. The request 214 may identify a particular portion of the content being requested.

The request 214 is initially received by the media streaming server. The media streaming server 206 could be a Flash Media Server™ (FMS), Windows Media Server™ (WMS), or other streaming media service. The media streaming server 206 is configured to communicate data with a content requester using a data streaming protocol (e.g., Real Time Messaging Protocol (RTMP)) in response to content requests. Upon receipt of request 214, the media streaming server 206 passes the request 214 to the media streaming broker 208 and waits for a response from the broker 208. As such, the media streaming broker 208 maintains the state of the media streaming server 206.

The media streaming broker 208 is operable to serve as a go-between for the media streaming server 206 and the stream caching module 210. As such, the media streaming broker 208 facilitates communications between the media streaming server 206 and the stream caching module 210 to thereby support streaming of content. In one embodiment, the media streaming broker 208 is a software plug-in that uses application programming interfaces (APIs) of the media streaming server 206 to communicate with the media streaming server 206. The media streaming broker 208 is operable to handle requests from the media streaming server 206, maintain some state of the media streaming server 206, and notify the media streaming server when content is in the cache 212. When the media streaming broker 208 receives a content request, the broker 208 generates a content request to the stream caching module 210.

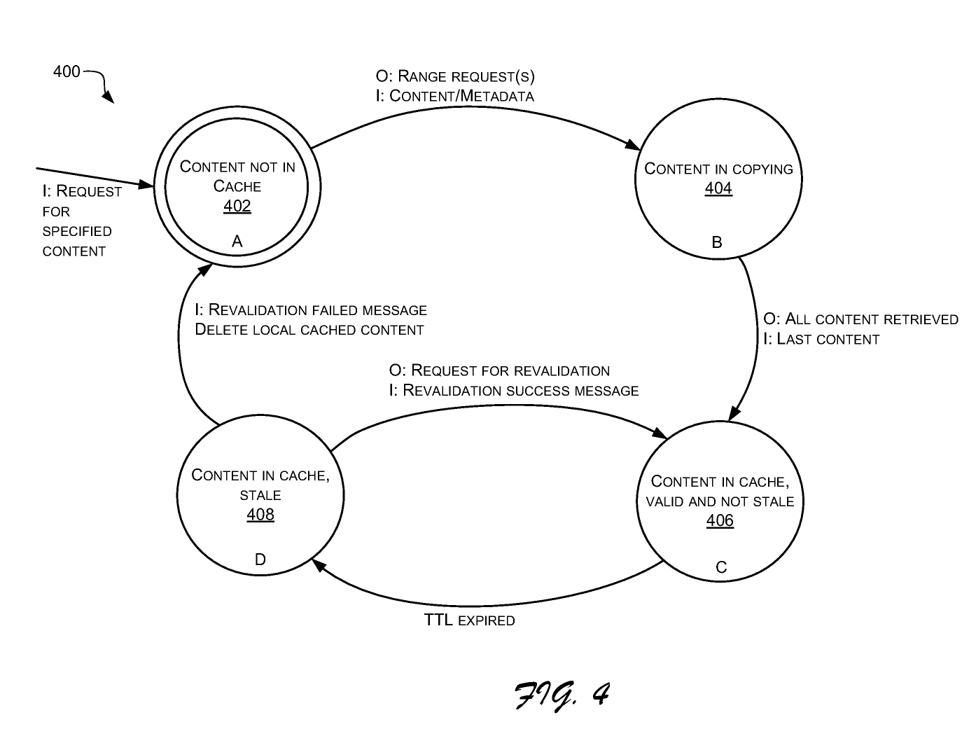

The stream caching module (SCM) 210 includes functionality for responding to content requests from the broker 208. In one embodiment, shown in FIG. 3, which is discussed in conjunction with FIG. 2, the SCM 210 includes a streaming request handler 302, a cache manager 304 and a data transport interface 306. The streaming request handler 302 receives the request from the broker 208 and queries the cache manager 304 whether the requested content is in the cache 212. The cache manager 304 determines if the requested content exists in the cache 212.

If the requested content is in the cache 212, the cache manager 304 of the SCM 210 checks the age of the content to determine if the content is stale. Generally, each content item has an associated time-to-live (TTL) value. The cache manager 304 notifies the request handler 302 of the results of the checks on the requested content; i.e., whether the content exists, and if so, whether the content is stale.

If the content exists in the cache 212 and is not stale, the request handler 302 notifies the media streaming server 206 via the media streaming broker that the content is ready to be streamed and provides a location in the cache 212 from which the content can be read. If the content is not in the cache 212, or the content is stale, the request handler 302 notifies the data transport interface 306. The data transport interface 306 is configured to communicate over a data transport channel, such as an HTTP channel 216, to the MAS 204.

The data transport interface 306 transmits a request 218 to the MAS 204 identifying the requested content. The request 218 may be one of several different types of requests, depending on the situation. For example, if it was determined that the requested content was in the cache 212, but the content was stale, the data transport interface 306 transmits a HEAD request (in the case of HTTP) to the MAS 204 indicating that the current state of the requested content in the local cache is stale. If the requested content is not in the cache 212, the data transport interface 306 transmits a GET (in the case of HTTP) request to the MAS 204 to retrieve at least a portion of the content from the MAS 204. The MAS 204 includes a data transport server 220, which receives and processes the request 218.

The data transport server 220 is configured to communicate via a data transport protocol, such as HTTP, over the data transport channel 216. Initially, the data transport server 220 determines if the content identified in the request 218 is in a content database 222 accessible to the MAS 204. The data transport server 220 queries the content database 222 for the requested content. Based on the response of the content database 222, the data transport server 220 generates a response 224, the contents of which depend on whether the requested content is in the database 222.

The response 224 generally includes a validity indicator, which indicates that the request 218 was or was not successfully received, understood and accepted. If the data transport protocol is HTTP, the response 224 indicator is a numerical code. If the requested content is not in the database 222, the code indicates invalidity, such as an HTTP 404 code, indicating the content was not found in the database 222.

If the requested content, for example file 226, is found in the database 222, the response 224 code will be a valid indicator, such as HTTP 2XX, where “X” can take on different values according to the HTTP definition. If the request 218 to the MAS 204 is a HEAD request, and the content is found in the database 222, the response 224 typically includes an HTTP 200 code. The response 224 to a HEAD request also includes information indicating whether the TTL of the content in cache 212 is revalidated or not. In the case of a GET request, and the requested content, e.g., file 226, is found in the database 222, the response 224 includes an HTTP code, along with a portion of the content 226.

The data transport interface 306 of the stream cache module 210 receives the response 224 and determines the appropriate action to take. In general, the data transport interface 306 notifies the streaming request handler 302 as to whether the content was found by the MAS 204 or not. If the content was not found by the MAS 204, and, assuming the cache manager 304 did not find the content in cache 212, the streaming request handler 302 notifies the media streaming server 206 via the media streaming broker 208 that the requested content is not found.

If the response 224 is a valid response to a HEAD request, the response 224 will indicate whether the TTL of stale content in cache 212 has been revalidated. If the TTL is revalidated, the cache manager 304 updates the TTL of the validated content and notifies the streaming request handler 302 that the content is available in cache 212 and is not stale. If the response 224 indicates that the stale content in cache 212 is not revalidated, the cache manager 304 deletes the stale content and indicates that the content is not in cache 212. The streaming request handler 302 then requests the content from the data transport interface 306.

A GET request can specify a portion of the content to be retrieved and if the GET request is valid, the response 224 will generally include the specified portion of the identified content. The request 218 can be a partial file request, or a range request, which specifies a range of data in the file 226 to be sent by the data transport server 220. The range may be specified by a beginning location and an amount; e.g., a byte count. Range requests are particularly useful for certain types of content and in response to certain requests, or other situations.

For example, if the requested file 226 is a Flash™ file, the first one or more GET requests will specify the portion(s) of the file 226 that are needed for the media streaming server 206 to immediately start streaming the file 226 to the requester. The entire file 226 is not required in order for the media streaming server 206 to start streaming the file 226 to the requester. In some cases, a particular portion of the content includes metadata about the content that enables the media streaming server 206 needs to start the streaming. Metadata may include file size, file format, frame count, frame size, file type or other information.

It has been found that for a Flash™ file, such as file 226, only a head portion 228 of the file 226 and a tail portion 230 of the file 226 are initially needed to start streaming the file 226 because the head 228 and the tail 230 include metadata describing the file 226. The remainder 232 of the file 226 can be obtained later. In one embodiment, the head portion 228 is the first 2 megabytes (MB) and the tail portion 230 is last 1 MB of the file 226, although these particular byte ranges may vary depending on various factors.

In the case of Flash™ file 226, after the head portion 228 and tail portion 230 of file 226 have been received by the data transport interface 306, the data transport interface 306 stores those portions in the cache 212, and the streaming request handler 302 is notified that the initial portions of the requested content are available in cache 212. The request handler 302 then notifies the streaming media server 206 of the location of the initial portions of the content in the cache 212. The streaming media server 206 then begins reading content from the cache 212 and sending streaming content 234 to the requester.

While the media streaming server 206 is streaming content to the requester, the SCM 210 continues to retrieve content of the file 226 from the MAS 204 until the remainder 232 is retrieved. The data transport interface 306 of the SCM 210 sends one or more additional GET requests to the data transport server 220 of the MAS 204, specifying range(s) of content to retrieve. In some embodiments, the data transport interface 306 requests sequential portions of the file 226 in set byte sizes, such as 2 MB or 5 MB at a time until the entire file 226 has been retrieved. The amount requested with each request can be adjusted depending on various parameters, including real time parameters, such as the latency of communications to and from the MAS 204.

During streaming of the requested content, the requester may issue a location-specific request requesting that data be streamed from a particular specified location within the content. The specified location may or may not yet be stored in the content cache 212. Such a location-specific request is received by the streaming media server 206 and passed to the media streaming broker 208. The streaming media broker 208 sends a request to the request handler 302 of the SCM 210. The request handler 302 requests that the cache manager 304 provide data from the specified location. The cache manager 304 attempts to retrieve data at the specified location in the file from the cache 212.

If the specified location is not yet in the cache 212, the cache manager 304 notifies the request handler 302. The request handler 302 then requests that the data transport interface 306 retrieve content at the specified location. In response, the data transport interface 306 sends a GET request specifying a range of data starting at the specified location, regardless of whether and where the data transport interface 306 was in the midst of downloading the file 226.

For example, if the location specified by the requester is at the end of the file 226, and the data transport interface 306 is in the process of sequentially downloading the file 226 and is at the beginning of the file 226, the data transport interface 306 interrupts its sequential download and sends a range request for data starting at the specified location. After content is retrieved from the specified location the data transport interface 306 resumes its sequential download from where it left off prior to receiving the location-specific request.

The components of the edge server 202, the MAS 204 and the stream cache module of FIG. 3 may be combined or reorganized in any fashion, depending on the particular implementation. For example, the data stores (e.g., content cache 212 and content data base 222) may be separate from their associated servers. The data stores may be any type of memory or storage and may employ any type of content storage method. The data stores, such as content cache 212 and database 222, may include database server software, which enables interaction with the data stores.

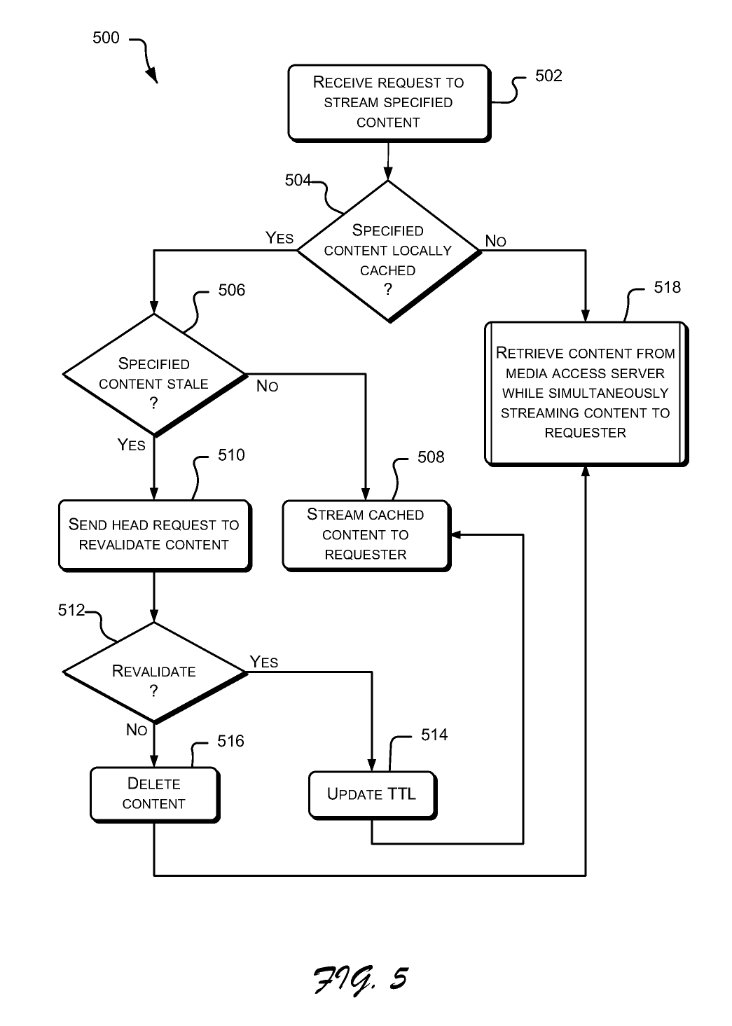

FIG. 4 is a state diagram 400 illustrating states that a streaming cache module, such as stream caching module 210 (FIG. 2), or similar component, may enter, and conditions that cause entry into and exit from those states. Initially, in this example scenario, the SCM 210 may enter state A 402 when the SCM 210 receives a request for specified content. It will be understood that the SCM 210 may enter another state initially, but for purposes of illustration, it is assumed here that the content specified in the request is not in local cache. In state A 402, the SCM determines that the specified content is not in the local cache. Upon determining that the specified content is not in the local cache, the SCM enters state B 404.

Upon entry into state B 404, the SCM outputs one or more range requests to a media access server and begins receiving content and/or metadata from the media access server (MAS). It is assumed in this case that the MAS has, or can obtain, a non-stale copy of the requested file.

With regard to range requests generated by the SCM 210, each of the one or more range requests specifies a beginning location of data and a range of data to be retrieved. The range request is a type of request supported by a data transport protocol, such as HTTP, and is recognized by the MAS, which includes a data transport server, such as an HTTP or web server. Thus, the MAS is able to read the range request(s) and respond with portions of the requested content identified in the range request(s).

An initial range request may specify a location in the file that includes metadata about the file that enables the streaming media server to promptly begin streaming the requested content. Such metadata can include control data or definitions that are used by the streaming media server to stream the content.

For example, in the case of a Flash™ file, the initial range request may specify the head of the Flash™ file, which gives information about the layout of the file, such as entire file size, frame size, total number of frames, and so on. In the case of Flash™ files, the initial range request, or one of the first range requests typically also specifies an end portion of the file because the end portion includes information used by the streaming media server to begin streaming the content of the file. For example, in some embodiments, the SCM generates a range request for the first two megabytes of a specified Flash™ file and the last one MB of the Flash™ file.

In state B 404, the SCM continues to request and receive content data until the entire file is retrieved. The content may be retrieved in sequential order from beginning to end of the content file, or the content may be retrieved in some other order. Out of sequential order retrieval may occur in response to a location-specific request from a user viewing the content to move to another specified location in the file. For example, the user may advance (or “rewind”) to a particular place in the streaming content file through the user's streaming media player.

When the user moves to a particular location in the streaming file, a request is sent to the SCM specifying the particular location in the file to move to. In response, in state B 404, the SCM generates a range request specifying the requested place in the file. The SCM may also notify the streaming media server (e.g., via the media streaming broker 208) when a portion or portions of the content have been stored in local cache, so that the streaming media server can begin streaming those portion(s).

After the requested content file is completely downloaded, the SCM may generate an output indicating the file is downloaded. The SCM then enters state C 406. In state C 406, the SCM waits until the content becomes stale. In state C 406, the SCM checks the age of the content file and compares the age to a specified “time-to-live” (TTL) value, which may be provided in a message from the MAS. When the content file becomes stale, the SCM enters state D 408.

In state D 408, the SCM sends a request to the MAS to revalidate the content file. The MAS may send a message indicating successful revalidation and a new TTL value. If so, the SCM returns to state C 406, where the SCM again waits until the TTL expires. On the other hand, while in state D 408, if the MAS does not revalidate the content, or generates a message indicating a revalidation failure, the SCM returns to state A 402. Before entering state A from state D, the SCM deletes the stale content.

With further regard to the revalidation of content, one embodiment involves the use of HTTP headers. In this embodiment the SCM sends a HEAD request and will expect one of the HTTP headers: Cache-Control or Expires. Those headers provide TTL information. After a given content file is fully downloaded, the SCM checks the TTL of the given content file in response to each incoming request for the file. If the content file ages past the TTL, then the SCM will send another HEAD request to revalidate the content. The response will depend on the media access server. For example, the Apache HTTP Server responds with a “200” response. Upon receipt of the “200” response SCM checks both the modifying time and the file size to make sure the cache content is still valid. As another example, the Microsoft's IIS™ HTTP server responds to a HEAD request with a “200” if the content is modified and stale, or “304” (not modified) if the content is still valid.

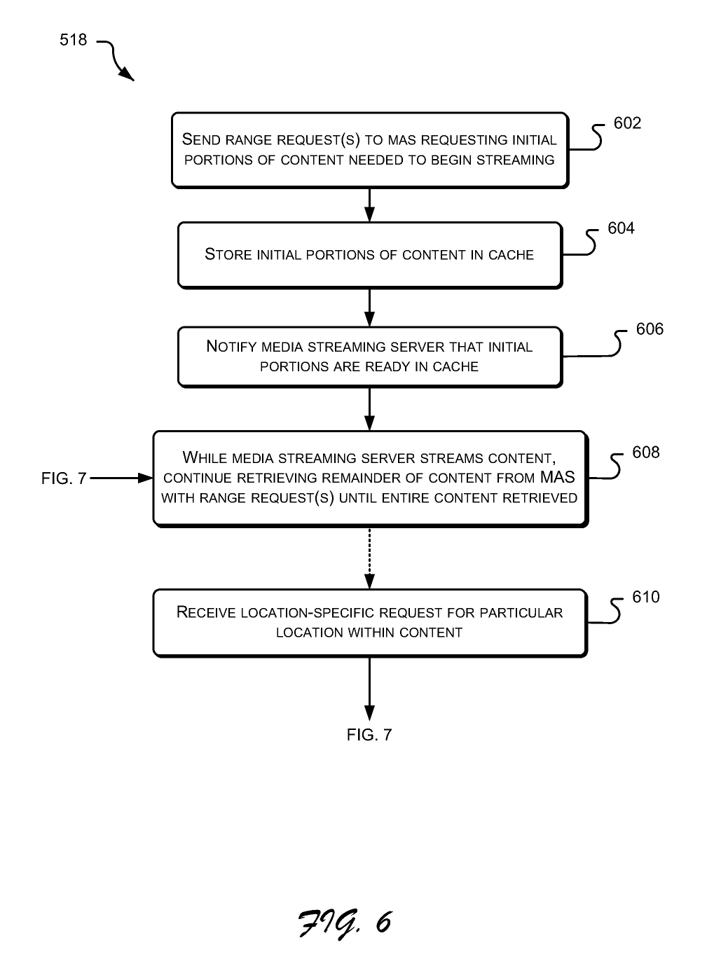

FIGS. 5-7 are flow charts illustrating processes for handling a request to deliver content. As described below, network analytics can be monitored and/or analyzed at any step in the processes. In general, the processes include determining whether content in a local cache is available to be streamed and, if so, streaming the requested content to the requester from the local cache; if not, content is revalidated and/or retrieved from a media access server and simultaneously streamed to the requester. The operations need not be performed in the particular order shown. The operations can be performed by functional modules such as one or more of the media streaming server 206, streaming media broker 208 and stream caching module 210 (FIG. 2), or other modules.

Referring specifically now to FIG. 5, in content request handling operation 500, a request is initially received for specified content in receiving operation 502. The requested content is identified in the request. A query operation 504 determines if the requested content exists in local cache. If it is determined that the requested content exists in local cache, another query operation 506 determines if the content in local cache is stale. In one embodiment, query operation 506 compares the age of the locally cached content to a TTL value associated with the content, and if the age is greater than the TTL value, the content is stale; otherwise the content is not stale.

If the locally cached content is determined to be not stale, the operation 506 branches “NO” to streaming operation 508. In streamlining operation 508, the locally cached content is streamed to the requester. On the other hand, if the locally cached content is determined to be stale, the operation 506 branches “YES” to sending operation 510.

In sending operation 510, a HEAD request is sent to a media access server (MAS) to revalidate the locally cached content. In another query operation 512 checks the response from the MAS to determine whether the locally cached content is revalidated. If the content is revalidated, the operation 512 branches “YES” to updating operation 514. Updating operation 514 updates the TTL value associated with the locally cached content, so that the locally cached content is no longer stale. The locally cached content is then streamed in streaming operation 508.

Returning to query operation 512, if the response from the MAS indicates that the locally cached content is not revalidated, the operation 512 branches “NO” to deleting operation 516. Deleting operation 516 deletes the locally cached content. After deleting operation 516, and if, in query operation 504 it is determined that the requested content is not in the local cache, the operation 504 branches to retrieving operation 518. In retrieving operation 518, the requested content is retrieved from the MAS while the content is simultaneously streamed to the requester.

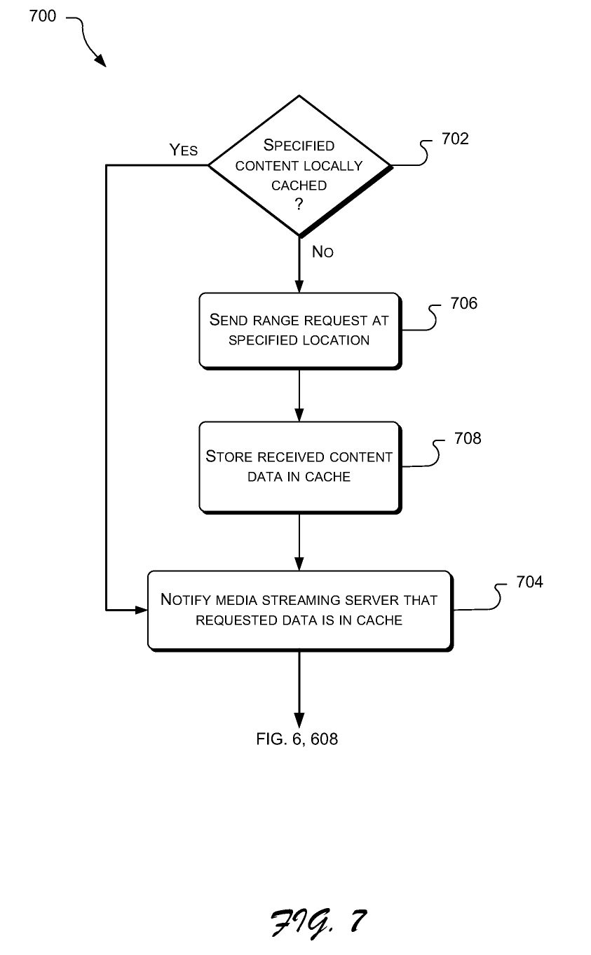

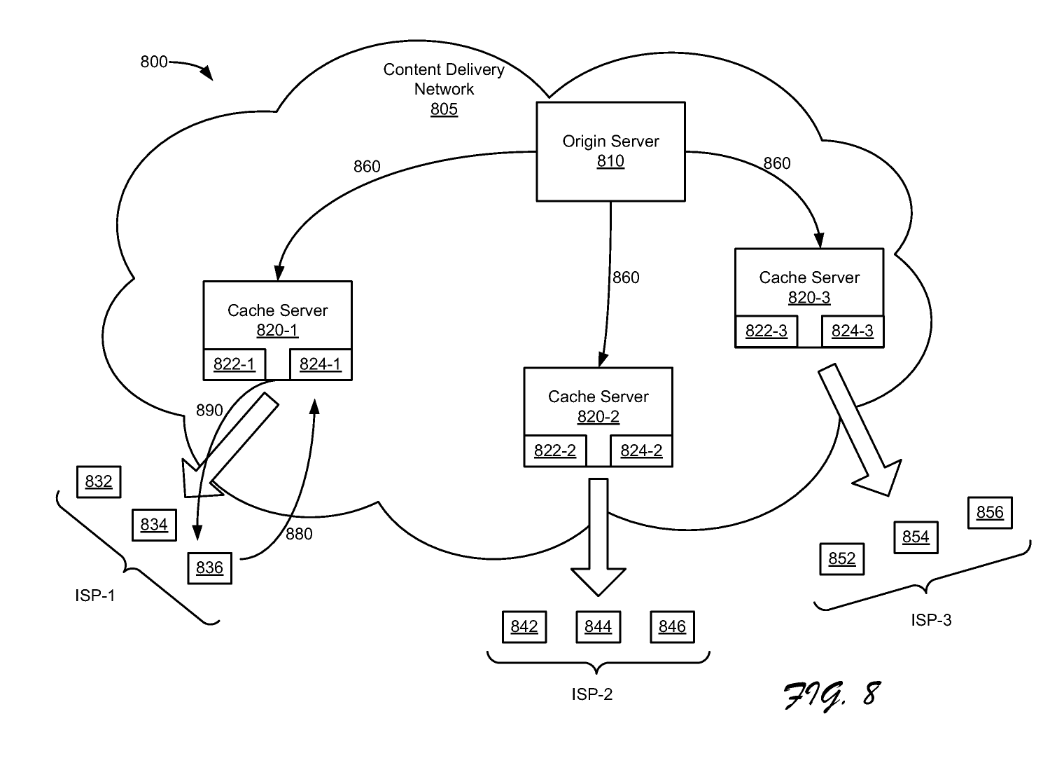

In one embodiment retrieving operation 518 retrieves the content using a data transport protocol (e.g., HTTP) while simultaneously delivering the content using a streaming media protocol. Examples of the retrieving operation 518 are shown in FIGS. 6-7 and described below.

FIG. 6 is a flow chart illustrating a simultaneous retrieval and streaming operation 518. The operations shown in FIGS. 6-7 are typically performed by a stream caching module, such as SCM 210 (FIG. 2), or similar component. The descriptions and scenarios described with respect to FIGS. 6-7 assume that the media access server (MAS) has a non-stale copy of the requested content.

In the case of HTTP, GET requests are sent to the MAS in sending operation 602. The initial one or more GET requests request portion(s) of the content that include metadata describing the layout of the content so that streaming of the content can begin. In one embodiment, for example, when the content to be retrieved in Flash™ media, the first one or two GET requests are range requests for a front portion of the content and an end portion of the content, which contain metadata used to begin streaming.

A storing operation 604 stores the retrieved portions of the content in cache. A notifying operation 606 notifies the streaming media server that the initial portions of the requested content are in cache and ready for streaming. The streaming media server will responsively begin streaming the requested content. Meanwhile, the SCM will continue to retrieve portions of the requested content in retrieving operation 608.

The retrieving operation 608 includes sending one or more additional GET requests for ranges of data in the requested content to the MAS. Content data received from the MAS is stored in cache where the streaming media server can access the content for continued streaming. In one embodiment, retrieving operation 608 retrieves portions of the content sequentially. The portions of content are of a size specified in the range requests. The portion sizes may be set or adapted, depending on various design or real-time parameters. In some embodiments, the portion size is set to 5 MB, but other sizes are possible and likely, depending on the implementation. Retrieving operation 608 continues until the entire content file has been retrieved and stored in cache.

During retrieving operation 608, a location-specific request may be received in receiving operation 610. When a location-specific request is received, the usual order of content retrieval (e.g., sequential) is temporarily interrupted to retrieve content data from the particular location specified in the location-specific request. A particular embodiment of a process of handling a location-specific request is shown in FIG. 7 and described further below.

After handling a location-specific request, the retrieving process 608 resumes. Retrieving operation 608 can continue to retrieve data sequentially after the location specified in the location-specific request, or the retrieving operation 608 could resume retrieval sequentially from where it was when the location-specific request was received.

FIG. 7 is a flow chart illustrating a location-specific requesting handling operation 700, which can be used to respond to a location-specific request when content is being streamed to the requester. As discussed, a location-specific request is a request to provide data at a particular location within content that is currently being streamed. Streaming media protocols are adapted to promptly move to a requested location within a content file.

However, in progressive download protocols, such as progressive download schemes often used with HTTP, moving to a particular place in the content while the content is being downloaded often causes delays because progressive download requires that all data prior to the desired location is downloaded first. Using the scheme shown in FIGS. 6-7 enables streaming of content that would otherwise be delivered via progressive download over a data transport channel, thereby reducing or removing delay associated with a move to a particular location in the content.

Initially, in moving operation 700, a query operation 702 determines whether data at the particular location specified in the location-specific request is stored in local cache. Query operation 702 may utilize a tolerance, whereby it is checked that at least a certain minimum amount of data after the specific location is stored in the local cache. For example, query operation 702 may check that at least 1 MB (or some other amount) of data after the specified location is stored in local cache. By using a tolerance, the moving operation 700 can avoid delays by ensuring that at least a minimum amount of data at the specified location is available for streaming.

If it is determined that at least the minimum amount of data is stored in local cache, the query operation 702 branches “YES” to notifying operation 704. Notifying operation 704 notifies the media streaming server of the location in cache that the requested data is at for delivery. After notifying operation 704, the operation 700 returns to retrieving operation 608 (FIG. 6). As discussed above, retrieving operation 608 may continue retrieving portions of the content after the location specified in the location-specific request, or resume retrieval from the location prior to receiving the location-specific request.

Referring again to query operation 702, if it is determined that the minimum amount of data at the specified location is not stored in cache, the query operation 702 branches “NO” to sending operation 706. Sending operation 706 generates a GET request specifying a range of data after the specified location. The amount of data specified in the range request can be the byte count retrieved in GET requests generated in operation 602 (FIG. 6), or some other byte count. A storing operation 708 receives the requested data and stores the data in the local cache. After storing operation 708, the moving operation 700 branches to notifying operation 704 where the media streaming server is notified of the location of the requested data in cache.

FIG. 8 is a block diagram of an exemplary network environment 800 having a content delivery network 805 that includes an origin server 810, a cache server 820-1, a cache server 820-2 and a cache server 820-3 (hereinafter collectively cache server 820). Each cache server 820 has a respective cache memory 822-1, 822-2, and 822-3, and a respective storage system 824-1, 824-2, and 824-3 (e.g., disk-based or other persistent storage). Cache server 820-1 services requests and provides content to end users 832, 834, and 836 (e.g., client computers) associated with Internet Service Provider 8 (ISP1). Cache server 820-2 services requests and provides content to end users 842, 844, and 846 associated with ISP2. Cache server 820-3 services requests and provides content to end users 852, 854, and 856 associated with ISP3. FIG. 8 shows a cache server dedicated for each ISP for simplicity. Many other implementations are also possible. For example, in various embodiments, one or more ISPs do not have a dedicated cache server, one or more ISPs have a plurality of dedicated cache servers, or the cache servers are not even be correlated to ISPs at all. In one embodiment, for example, one or more cache servers are located remotely (e.g., within an ISP's infrastructure or at an end user's site, such as on a local area network (LAN)) and interact with a remote origin server (e.g., the origin server 810 shown in FIG. 8).

The network environment 800 in FIG. 8 portrays a high-level implementation of content delivery network 805 suitable for implementing and facilitating functionality of the various embodiments described herein. Content delivery network 805 represents just one example implementation of a content delivery network and, as such, it should be noted that the embodiments described herein are similarly applicable for being implemented in any content delivery network configuration commonly practiced in the art. One example content delivery network is described in United States Published Patent Application no. US 2003/0065762 A1 entitled “Configurable adaptive global traffic control and management” filed by Paul E. Stolorz et al. on Sep. 30, 2002, which is incorporated by reference herein in its entirety.

During general operation, the origin server 810 distributes various content (e.g., depending on geography, popularity, etc.) to cache server 820 as shown by lines 860. Assume, for example, that end user 836 requests certain content (e.g., music, video, software, etc.) that is stored on the origin server 810. In this embodiment, the origin server 810 is configured to use the content delivery network 805 to serve content that it contains and optionally has already distributed the requested content to cache server 820-1. The end user 836 is redirected using any number of known methods to instead request the content from cache server 820-1. As shown in the exemplary embodiment of FIG. 8, the cache server 820-1 is configured/located to deliver content to end users in ISP1. The cache server 820-1 can be selected from the group of cache servers 820 using any number of policies (e.g., load balancing, location, network topology, network performance, etc.). End user 836 then requests the content from cache server 820-1 as shown by line 880. Cache server 820-1 then serves the content to end user 836 (line 890) either from cache 822-1 or, if the content is not in the cache, the cache server 820-1 retrieves the content from the origin server 810.

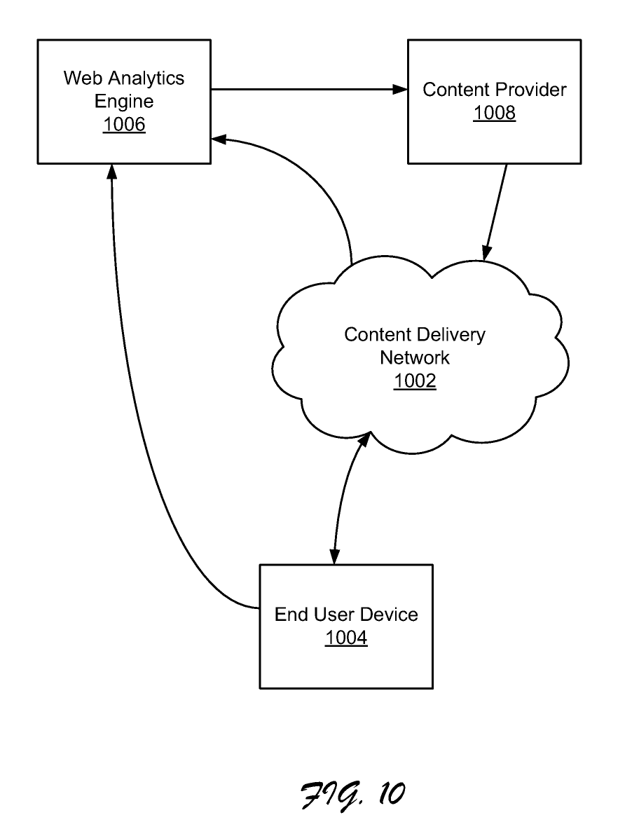

Although FIG. 8 shows the origin server 810 located as part of the content delivery network 805, the origin server 810 can also be located remotely from the content delivery network (e.g, at a content provider's site). FIG. 9 shows such an embodiment, in which a content delivery network 905 interacts with one or more origin servers 910 located at various content provider's sites 908. In this embodiment, the content delivery network 905 includes a plurality of cache servers 920. The cache servers 920 service requests and provide content to end users 932, 942, and 952 (e.g., client computers). The origin servers 910 distribute various content to cache servers 920 as described above with respect to FIG. 8.

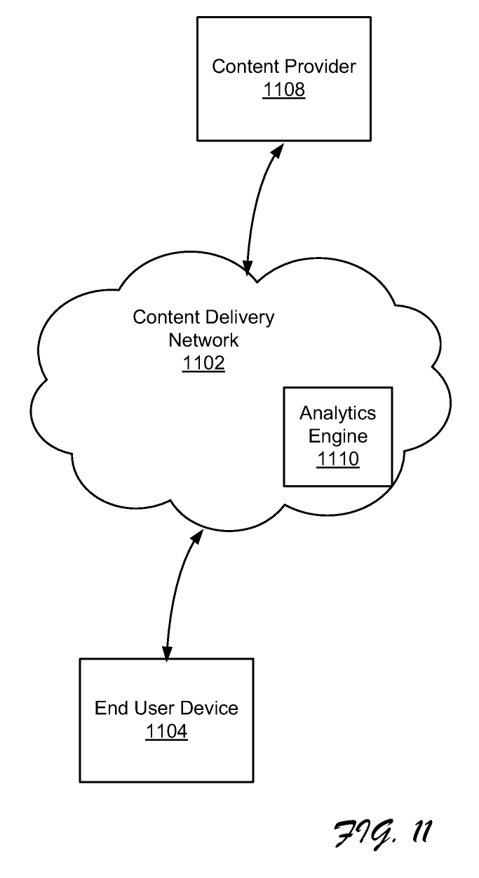

FIG. 10 illustrates an example web analytics monitoring and reporting system 1000 including a content delivery network 1002. As shown in FIG. 10, an end user device 1004 is connected to the content delivery network 1002 to receive content from the network 1002. Javascripts executing on the end user device 1004 collect data and forward the data to a web analytics engine 1006 of a web analytics vendor. The data collected by the Javascripts running on the end user device 1004 relates to operations performed at the end user device (e.g., keyword monitoring, cookie tracking, and the like), but does not include operations and performance monitored within the content delivery network 1002 that occurred in delivering content to the end user. The web analytics engine 1006 compiles and processes the analytics data it receives from the end user device 1004.

As a supplement to the end user data, the content delivery network 1002 monitors and compiles analytics data from within the content delivery network 1002 and provides the analytics data to the web analytics engine 1006. The content delivery network 1002, for example, monitors one or more content delivery transactions within the content delivery network 1002. In an embodiment, for example, the monitoring provides analytics data and/or to compiles analytics data for use by the web analytics engine 1006. In one implementation, for example, the web analytics engine 1006 uses the analytics data received from the content delivery network 1002 to supplement analytics received from other sources, such as end user devices 1004. Examples of download statistics that may be collected and/or compiled include transactional data, such as speed, bandwidth, performance, delivery time, successful download, paused download, terminated download, quality of service and/or experience information, and the like. In one embodiment, for example, the content delivery network 1002 monitors and logs information about served transactions. For example, a download receipt can be recorded for reporting each time an end user successfully and/or unsuccessfully downloads a particular piece of content.

In one embodiment, for example, download information and statistics are used to determine technical issues as well as a quality of experience provided to an end user. Thus, in one embodiment, a content provider 1008 uses this type of information to maximize the effectiveness, quality, stickiness, etc. of the content being provided. In another embodiment, the a content delivery network or network operator uses information and statistics to determine characteristics of services for individual customers or properties, categories of customers, properties, content types, populations of client devices, or the like.

In an embodiment, the content delivery network 1002 also packages and/or formats analytics data determined or received by the content delivery network for dissemination to the analytics engine 1006 or directly to a content provider 1008. In this manner the data can be formatted or configured to be accessible to an analytics engine 1006 or content provider 1008 without having to go through a third party vendor. In one embodiment, for example, the content delivery network creates a formatted hypertext transfer protocol (HTTP) request to a designated collection service uniform resource locator (URL), thus providing server-side intelligence to format the request—substituting appropriate configuration metadata where appropriate, and issuing the resulting request to the analytics engine 1006.

In one embodiment, the content provider tags content or other information. The content provider in an embodiment, for example, classifies or identifies a request, a requesting client, or requested content for analysis within the content delivery network and/or the analytics engine. Examples of tags include URL tags (e.g., via naming conventions or queystrings), tags in HTTP headers, or other types of tags. In one implementation, the tag or identifier is used to provide the content delivery network with the ability to aggregate aspects of multiple requests across a given session for, such as for pre-aggregation prior to sending collected data to the analytics engine.

In an embodiment, the content delivery network 1002 may also provide a collection point for the analytics vendor. In one particular implementation, for example, the content delivery network 1002 uses the analytics providers' hostname and/or domain name so that analytics vendor assigned cookies that identify the specific client can be included with or associated with the collected information to be sent back to the analytics engine.

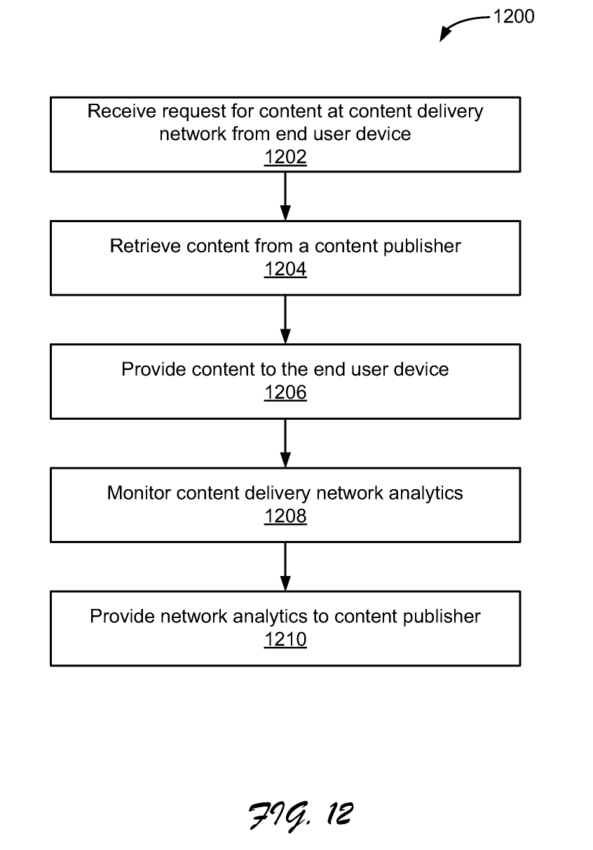

FIG. 11 illustrates another example of a web analytics monitoring and reporting system 1100 including a content delivery network 1102, an end user device 1104, and a content provider 1108. In this example, the content delivery network 1102 collects analytics data from within the content delivery network as described above with respect to FIG. 2 and further receives analytic data retrieved at the end user device 1104 (e.g., using a Javascript executing on the end user device 1104). In this example, the content delivery network comprises an internal analytics engine 1110, compiles the collected data, and provides it to the content provider 1108 in a format that is useful for the content provider 1108.

The analytics collection within a content delivery network, in an embodiment, is configurable. In this embodiment, for example, a determination is made as to the type of data that is to be collected and how that data is to be collected. Further, in another embodiment, the data itself is formatted to simulate a format used by a particular analytics engine or a particular content provider that may be interested in the data. In addition, particular features can be turned on or off depending on the application or an interest of an ultimate purchaser of the data. Configuration rules are also be established to allow for automated configuration of the data collection and/or provision. In one embodiment, for example, metadata associated with particular content is used to flag analytics data for collection and/or reporting.

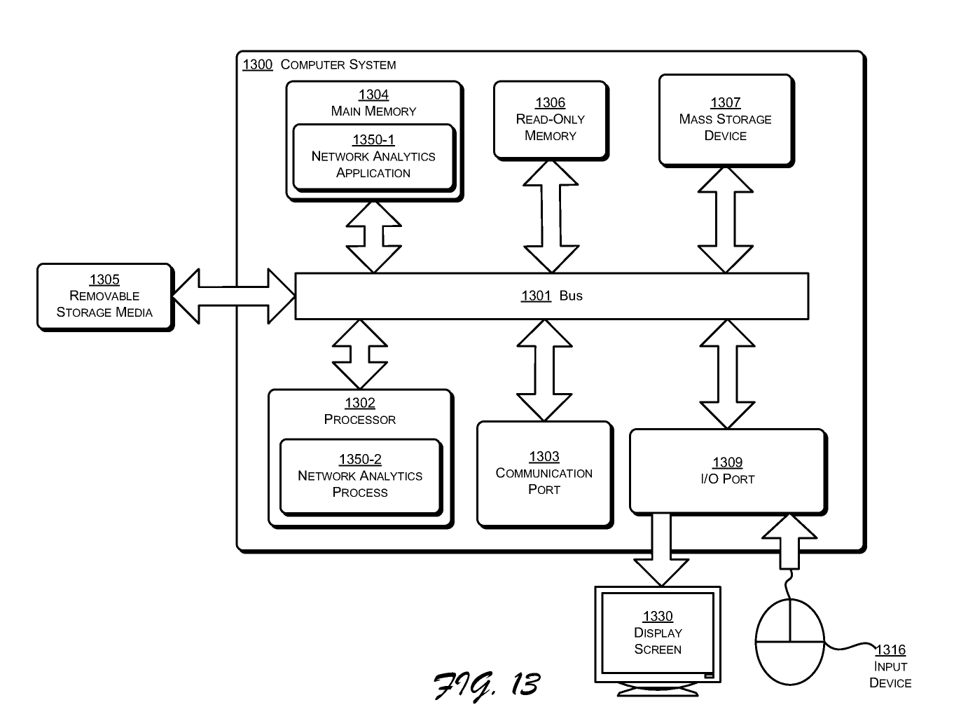

FIG. 12 illustrates a block diagram of an example process 1200 for monitoring and reporting network analytics data. In FIG. 12, a request for content is received from an end user device at a content delivery network in operation 1202. The content delivery network retrieves the content from a content publisher in operation 1204, and begins to provide the content to the end user device in operation 1206. The content delivery network monitors network analytics for the content delivered from the content publisher in operation 1208. This monitoring, for example, may monitor any network analytics related to the delivery of the content from the content publisher to the end user device using the content delivery network. In one particular embodiment, for example, a content server of the content delivery network is used to monitor one or more download statistics related to the transfer of the requested content to the end user device. Examples of such download statistics include byte count, request count, HTTP status, referrer domains (e.g., by time period), requestor geography, server location, download completion or incompletion, cache hit rate, authentication status, encoding type, and the like.

The monitored analytics data is then provided to the content publisher in operation 1210. As discussed above, in one embodiment, the data is provided via a third party analytics engine that receives the data and forwards the data (optionally with further processing) to the content publisher. In another embodiment, the analytics data is provided directly to the content publisher (optionally with further processing) from the content delivery network.

In an exemplary embodiment, content analytics collected within a content delivery network provides market intelligence and analytics capabilities for caching delivery. In one embodiment, for example, reporting collections can be defined (e.g., within the content delivery network, by a content provider, by an analytics vendor, by an end user, or the like). Then analytics information and/or statistics are collected within those definitions. The resulting information and/or statistics is also reported (e.g., discretely and/or in summary form) to one or more parties.

In one particular embodiment, a party defines data sets (e.g., via pattern or token matching) as a collection to capture the defined data set (e.g., a collection of URLs) useful to the party. In one implementation, for example, the data set includes a set of URLs defined as a collection, such as using pattern matching against strings in a URL, by matching tokens in a query string of an HTTP request or the like.

Once the data is collected, the data is reported in any number of views. In one embodiment, for example, the data can be viewed individually or collectively. Examples of aggregate data presentation, for example, include summary information on reporting URLs, server statuses, region information, summary reporting across a collection of content for traffic, errors, usage, and the like (e.g., by geography, time, customer, or the like). Similarly, in another embodiment, URL-specific detail usage data for a subset of collections within a property is also reported. In other examples, lists, charts, maps, or other representations are used to report collected data (e.g., a list of status codes for a collection, a list of URLs with that status code, a chart of requests over time, a link to a larger trend chart of requests for the URL, and the like). Comparison tools are further examples of reporting in which trends of two or more collections (e.g., within a property) are compared (e.g., charted) against each other for deeper analysis or for comparison of two or more assets within a collection.

Examples of data presentation further include a time series chart by time period (e.g., day, hour, minute, etc.) of traffic within a collection by requests, bytes, or the like; HTTP status codes; sum of traffic by status codes or selection of one code to drill down and view data (e.g., URLs) with that code; a map (e.g., a world map) showing traffic by server node, requestor region (e.g., country, state, region, etc.); delivery performance statistics (e.g., download completion, cache efficiency, and authentication status); traffic analysis (e.g., in aggregate, at URL level (by customizable groups of URLs or by individual URLs)); and the like.

FIG. 13 is a schematic diagram of a computer system 1300 upon which embodiments of the present invention may be implemented and carried out. For example, one or more computing devices 1300 may be used to monitor and/or analyze network analytics (e.g., for streamed content within a content distribution network). Computer system 1300 generally exemplifies any number of computing devices, including general purpose computers (e.g., desktop, laptop or server computers) or specific purpose computers (e.g., embedded systems).

According to the present example, the computer system 1300 includes a bus 1301 (i.e., interconnect), at least one processor 1302, at least one communications port 1303, a main memory 1304, a removable storage media 1305, a read-only memory 1306, and a mass storage 1307. Processor(s) 1302 can be any known processor, such as, but not limited to, an Intel® Itanium® or Itanium 2® processor(s), AMD® Opteron® or Athlon MP® processor(s), or Motorola® lines of processors. Communications ports 1303 can be any of an RS-232 port for use with a modem based dial-up connection, a 10/100 Ethernet port, a Gigabit port using copper or fiber, or a USB port. Communications port(s) 1303 may be chosen depending on a network such as a Local Area Network (LAN), a Wide Area Network (WAN), or any network to which the computer system 1300 connects. The computer system 1300 may be in communication with peripheral devices (e.g., display screen 1330, input device 1316) via Input/Output (I/O) port 1309.

Main memory 1304 can be Random Access Memory (RAM), or any other dynamic storage device(s) commonly known in the art. Read-only memory 1306 can be any static storage device(s) such as Programmable Read-Only Memory (PROM) chips for storing static information such as instructions for processor 1302. Mass storage 1307 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 1301 communicatively couples processor(s) 1302 with the other memory, storage and communications blocks. Bus 1301 can be a PCI/PCI-X, SCSI, or Universal Serial Bus (USB) based system bus (or other) depending on the storage devices used. Removable storage media 1305 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), etc.

Embodiments herein may be provided as a computer program product, which may include a machine-readable medium having stored thereon instructions, which may be used to program a computer (or other electronic devices) to perform a process. The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

As shown, main memory 1304 is encoded with network analytics application 1350-1 that supports functionality as discussed herein. Network analytics application 1350-1 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 1302 accesses main memory 1304 via the use of bus 1301 in order to launch, run, execute, interpret or otherwise perform the logic instructions of the network analytics application 1350-1. Execution of network analytics application 1350-1 produces processing functionality in network analytics process 1350-2. In other words, the network analytics process 1350-2 represents one or more portions of the network analytics application 1350-1 performing within or upon the processor(s) 1302 in the computer system 1300.

It should be noted that, in addition to the network analytics process 1350-2 that carries out operations as discussed herein, other embodiments herein include the network analytics application 1350-1 itself (i.e., the un-executed or non-performing logic instructions and/or data). The network analytics application 1350-1 may be stored on a computer readable medium (e.g., a repository) such as a floppy disk, hard disk or in an optical medium. According to other embodiments, the network analytics application 1350-1 can also be stored in a memory type system such as in firmware, read only memory (ROM), or, as in this example, as executable code within the main memory 1304 (e.g., within Random Access Memory or RAM). For example, network analytics application 1350-1 may also be stored in removable storage media 1305, read-only memory 1306, and/or mass storage device 1307.

Example functionality supported by computer system 1300 and, more particularly, functionality associated with network analytics application 1350-1 and network analytics process 1350-2 is discussed above with reference to FIGS. 1-12.

In addition to these embodiments, it should also be noted that other embodiments herein include the execution of the network analytics application 1350-1 in processor(s) 1302 as the network analytics process 1350-2. Thus, those skilled in the art will understand that the computer system 1300 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

The embodiments described herein are implemented as logical steps in one or more computer systems. The logical operations invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

Various modifications and additions can be made to the example embodiments discussed herein without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed is:

1. A method for providing network analytics for a content delivery network, the method comprising:
providing a content delivery network, wherein the content delivery network comprises at least one content server;
detecting a request for network analytics from the content delivery network;
extracting network analytics at the at least one content server; and
disseminating the network analytics from the content delivery network.

2. A method as recited in claim 1 wherein the operation of disseminating comprises disseminating the network analytics to an analytics engine.

3. A method as recited in claim 1 wherein the operation of disseminating comprises disseminating the network analytics to a content publisher.

4. A method as recited in claim 1 further comprising packaging the networks analytics for delivery from the content delivery network.

5. A method as recited in claim 4 wherein the packaging comprises formatting the network analytics for receipt by a web analytics engine.

6. A method as recited in claim 4 wherein the packaging comprises accommodating an external consumer format.

7. A method as recited in claim 1 wherein the network analytics extracted from the at least one content server with analytics is supplemented with network analytics received from an end user device.

8. A method as recited in claim 1 wherein the extracting operation is based on metadata associated with content being delivered via the at least one content server.

9. A method as recited in claim 1 wherein the extracting operation is performed based on one or more rules applied to the request for network analytics.

10. A method as recited in claim 1 wherein the network analytics are intermittently extracted at the at least one content server.

11. A method for managing network analytics on a content delivery network, the method comprising:
capturing transactional data;
selectively configuring which events generate transactional data;
configuring a destination for data transmittal; and
configuring a format of the data for transmittal to the destination.

12. A method as recited in claim 11 wherein the capturing operation is performed via a universal resource locator (URL).

13. A method as recited in claim 12 wherein the URL is associated with one or more of the following: a query string, a cookie, a header, an HTTP header, metadata, and metadata included with a request.

14. A system for providing network analytics comprising:
a content delivery network comprising at least one content server,
wherein the content delivery network is configured to detect a request for network analytics, extract the network analytics at the at least one content server, and disseminate the network analytics from the content delivery network.

15. A system as recited in claim 14 wherein the content delivery network is configured to disseminate the network analytics to an analytics engine.

16. A system as recited in claim 14 wherein the content delivery network is configured to disseminate the network analytics to a content publisher.

17. A system as recited in claim 14 wherein the content delivery network is further configured to package the network analytics for delivery from the content delivery network.

18. A system as recited in claim 17 wherein the content delivery network is configured to package the network analytics formatted for receipt by a web analytics engine.

19. A system as recited in claim 17 wherein the content delivery network is configured to package the network analytics for accommodating an external consumer format.

20. A system as recited in claim 14 wherein the content delivery network is configured to supplement the network analytics extracted from the at least one content server with analytics received from an end user device.

21. A system as recited in claim 14 wherein the content delivery network is configured to extract the network analytics based on metadata associated with content being delivered via the at least one content server.

22. A system as recited in claim 14 wherein the content delivery network is configured to extract the network analytics based on one or more rules applied to the request for network analytics.

23. A system as recited in claim 14 wherein the content delivery network is configured intermittently extract the network analytics at the at least one content server.
